(19) United States
(12) Patent Application Publication
(10) Pub. No.: US 2021/0173100 A1
(43) Pub. Date: Jun. 10, 2021

(54) SCINTILLATOR PANEL AND X-RAY DETECTOR USING SAME

(71) Applicant: Toray Industries, Inc., Tokyo (JP)

(72) Inventors: Sho Miyao, Otsu-shi, Shiga (JP); Kazuki Shigeta, Otsu-shi, Shiga (JP); Hirotoshi Sakaino, Otsu-shi, Shiga (JP)

(73) Assignee: Toray Industries, Inc., Tokyo (JP)

(21) Appl. No.: 16/771,020

(22) PCT Filed: Dec. 19, 2018
(86) PCT No.: PCT/JP2018/046718

§ 371 Date: Jun. 9, 2020

(30) Foreign Application Priority Data
Dec. 27, 2017 (JP) 2017-250589

(51) Int. Cl. G01T 1/20; G01T 1/202; G21K 4/00

(52) U.S. Cl. CPC G01T 1/2002; G01T 1/2023; G21K 2004/10; G21K 2004/06; G21K 4/00

(57) ABSTRACT

Provided are a scintillator panel and an X-ray detector which have high sensitivity and sharpness. The scintillator panel includes a substrate and a scintillator layer containing a binder resin and a phosphor, wherein the scintillator panel further contains an organic compound having the maximum peak wavelength of light emission in the wavelength region of from 450 to 600 nm.

### CROSS REFERENCE TO RELATED APPLICATIONS

This is the U.S. National Phase application of PCT/JP2018/046718, filed Dec. 19, 2018, which claims priority to Japanese Patent Application No. 2017-250589, filed Dec. 27, 2017, the disclosures of each of these applications being incorporated herein by reference in their entireties for all purposes.

### FIELD OF THE INVENTION

The present invention relates to a scintillator panel and to an X-ray detector, an X-ray fluoroscope, and an X-ray CT device for each of which such a scintillator panel is used.

### BACKGROUND OF THE INVENTION

X-ray images captured using films have been widely used heretofore in medical settings. However, since an X-ray image captured using a film provides analog image information, in recent years, digital plate-shaped radiation detectors such as computed radiography (CR) and flat panel radiation detectors (flat panel detector: FPD) have been developed.

In an FPD, a scintillator panel is used to convert a radiation into visible light. A scintillator panel contains a radiation phosphor such as gadolinium oxysulfide (GOS), and the radiation phosphor emits visible light in response to an applied radiation. The light emitted from the scintillator panel is converted into electric signals using a sensor (a photoelectric conversion layer) having a TFT or a CCD, and in this way, radiological information is converted into digital image information.

In recent years, it has been desired that X-ray detectors can be used with a smaller dose of radiation. For example, medical settings require that test subjects in X-ray diagnosis and the like should be exposed to a dose of radiation which is decreased as much as possible. With a decreased dose of radiation used for an X-ray detector, however, the brightness of the scintillator panel becomes relatively low. This makes it important for such a scintillator panel that the emitted light is taken out at high efficiency with a small dose of radiation. Furthermore, light emitted by a scintillator panel needs to be detected through a photoelectric conversion layer at high sensitivity. In addition, X-ray non-destructive tests in industrial applications require X-ray detectors to be enhanced in sensitivity, for example, the emitted-light takeout efficiency of a scintillator panel, the detection efficiency of a photoelectric conversion layer, and the like, because a decrease in an exposure dose of radiation leads to a decrease in cycle time, although such a dose is not restricted as much as an exposure dose of radiation in medical applications.

The emitted-light takeout efficiency of a scintillator panel and the detection efficiency of a photoelectric conversion layer are decreased, for example, because matching is insufficient between a light emission wavelength of a phosphor and a wavelength region in which the detection efficiency of a photoelectric conversion layer is high (causing a decrease in detection efficiency), and/or because light emitted from a phosphor is scattered and absorbed in a scintillator layer (causing a decrease in takeout efficiency).

In view of this, proposed technologies for enhancing sensitivity are, for example: a scintillator including a first phosphor containing an inorganic fluorescent compound and a second phosphor containing a phosphor resin and a wavelength conversion compound (see, for example, Patent Document 1); a radiation detector having a scintillator crystal, a photodetector, and a wavelength conversion layer (see, for example, Patent Document 2).

### PATENT DOCUMENTS

Patent Document 1: Japanese Patent Laid-open Publication No. 2014-48270
Patent Document 2: Japanese Patent Laid-open Publication No. 2010-169673

### SUMMARY OF THE INVENTION

However, the technology described in Patent Document 1 causes still insufficient matching between the wavelength of light emitted from a phosphor and converted as a wavelength and the wavelength region in which the detection efficiency of a photoelectric conversion layer is high, and thus, the detection efficiency of the photoelectric conversion layer is insufficient. Additionally according to Patent Documents 1 to 2, light emitted from a phosphor and converted as a wavelength is significantly scattered in a scintillator layer, and thus, visible light is taken out at insufficient efficiency. This poses a problem in that the sensitivity and sharpness of a scintillator panel are insufficient.

In view of the above-mentioned problems, an object of the present invention is to provide a scintillator panel having excellent sensitivity and sharpness.

To solve the above-mentioned problems, the present invention mainly has the following constituents. That is, according to an embodiment of the present invention is a scintillator panel including a substrate and a scintillator layer containing a binder resin and a phosphor, wherein the scintillator layer further contains an organic compound having the maximum peak wavelength of light emission in the wavelength region of from 450 to 600 nm.

A scintillator panel according to the present invention has excellent sensitivity and sharpness.

### BRIEF DESCRIPTION OF DRAWINGS

FIG. 1 is a schematic cross-sectional view of one aspect of an X-ray detector including a scintillator panel according to an embodiment of the present invention.

FIG. 2 is a graph showing the absorption spectra of a perylene compound, pyrromethene compounds A to D, coumarin compound, anthracene compound, and POPOP which were used in Examples and Comparative Examples.

FIG. 3 is a graph showing the light emission spectra of a perylene compound, pyrromethene compounds A to D, coumarin compound, anthracene compound, and POPOP which were used in Examples and Comparative Examples.

FIG. 4 is a graph showing a light emission spectrum of the scintillator panel in Example 1.

FIG. 5 is a graph showing a light emission spectrum of the scintillator panel in Example 2.

FIG. 6 is a graph showing a light emission spectrum of the scintillator panel in Example 6.

FIG. 7 is a graph showing a light emission spectrum of the scintillator panel in Example 7.

FIG. 8 is a graph showing a light emission spectrum of the scintillator panel in Comparative Example 1.

### DETAILED DESCRIPTION OF EMBODIMENTS OF THE INVENTION

A scintillator panel according to an embodiment of the present invention has at least a substrate and a scintillator layer. A scintillator layer absorbs energy of incident radiation such as X-rays and emits electromagnetic waves in the wavelength range of from 300 nm to 800 nm, that is, an arbitrary light, mainly visible light, in the range of from ultraviolet light to infrared light. The scintillator layer contains at least a binder resin and a phosphor. The binder resin causes a plurality of phosphors to be bonded to one another, and has the effect of fixing the relative positions of the phosphors in the scintillator layer. The phosphor absorbs energy of radiation such as X-rays and has the effect of emitting an arbitrary light, mainly visible light, in the range of from ultraviolet light to infrared light.

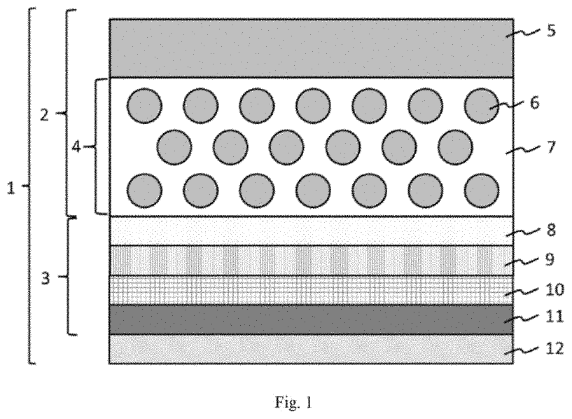

FIG. 1 is a schematic view of one aspect of an X-ray detector including a scintillator panel according to an embodiment of the present invention. The X-ray detector 1 has a scintillator panel 2, an output substrate 3, and a power source unit 12.

The scintillator panel 2 has a substrate 5 and a scintillator layer 4. The scintillator layer 4 contains a phosphor 6, a binder resin 7, and an organic compound, which is not shown, having the maximum peak wavelength of light emission in the wavelength region of from 450 to 600 nm.

The output substrate 3 has a photoelectric conversion layer 9 and an output layer 10 on a substrate 11. In general, the photoelectric conversion layer 9 is two-dimensionally formed pixels and has a photosensor and TFT, which are not shown. A barrier membrane layer 8 may be on the photoelectric conversion layer 9. It is preferable that the light exit surface of the scintillator panel 2 and the photoelectric conversion layer 9 of the output substrate 3 are bonded or adhered to each other with a barrier membrane layer 8 interposed therebetween.

The light emitted from the scintillator layer 4 reaches the photoelectric conversion layer 9 to be photoelectrically converted and outputted.

Materials to be included in a substrate used for a scintillator panel according to the present invention are preferably radiolucent, and examples thereof include various kinds of glasses, polymer materials, metals, and the like. Examples of glasses include quartz, borosilicate glass, chemically strengthened glasses, and the like. Examples of polymer materials include: cellulose acetate; polyesters such as polyethylene terephthalate; polyamides; polyimides; triacetate; polycarbonates; carbon fiber reinforced resins; and the like. Examples of metals include aluminum, iron, copper, and the like. These may be used in combination of two or more kinds thereof. Among these, particularly polymer materials having high radiolucency are preferable. In addition, materials having excellent flatness and heat resistance are preferable.

From the viewpoint of making the scintillator panel more lightweight, the substrate preferably has a thickness of 2.0 mm or less, more preferably 1.0 mm or less, for example, in cases where the substrate is a glass substrate. Alternatively, the substrate preferably has a thickness of 3.0 mm or less in cases where the substrate is composed of a polymer material.

A scintillator layer used for a scintillator panel according to an embodiment of the present invention contains at least a binder resin and a phosphor, and further contains an organic compound having the maximum peak wavelength of light emission in the wavelength region of from 450 to 600 nm.

Examples of binder resins include thermoplastic resins, thermosetting resins, photo-curable resins, and the like. More specific examples include: acrylic resins, cellulosic resins, epoxy resins, melamine resins, phenol resins, urea resins, vinyl chloride resins, butyral resins, and silicone resins; polyester resins such as polyethylene terephthalate and polyethylene naphthalate; polyethylene, polypropylene, polystyrene, polyvinyl toluene, and polyphenyl benzene; and the like. Two or more of these may be contained. Among these, resins selected from acrylic resins, cellulosic resins, butyral resins, polyester resins, and polystyrene are preferable.

Binder resins have an impact on the takeout of light from a scintillator layer, and thus, resins having high transparency are preferable in that such resins can enhance the light takeout efficiency.

Examples of phosphors include: inorganic phosphors such as sulfide phosphors, germanate phosphors, halide phosphors, barium sulfate phosphors, hafnium phosphate phosphors, tantalate phosphors, tungstate phosphors, cerium-activated rare earth silicate phosphors, praseodymium-activated rare earth oxysulfide phosphors, terbium-activated rare earth oxysulfide phosphors, terbium-activated rare earth phosphate phosphors, terbium-activated rare earth oxyhalide phosphors, thulium-activated rare earth oxyhalide phosphors, europium-activated alkaline earth metal phosphate phosphors, europium-activated alkaline earth metal fluoride halide phosphors, and europium-activated rare earth oxysulfide phosphors; and organic phosphors such as p-terphenyl, p-quaterphenyl, 2,5-diphenyloxazole, 2,5-diphenyl-1,3,4-oxodiazole, naphthalene, diphenylacetylene, and stilbenzene. Two or more of these may be contained. Among these, phosphors selected from halide phosphors, terbium-activated rare earth oxysulfide phosphors, and europium-activated rare earth oxysulfide phosphors are preferable, and terbium-activated rare earth oxysulfide phosphors are more preferable.

Examples of the form of a phosphor include particles, needles, scales, and the like. Among these, particles are preferable. A phosphor in the form of particles is more uniformly dispersed in a scintillator layer, and thus, makes it possible to inhibit light from being unevenly emitted from a phosphor in a scintillator layer and to allow light to be uniformly emitted.

A scintillator panel according to an embodiment of the present invention is characterized in that a scintillator layer contains an organic compound having the maximum peak wavelength of light emission in the wavelength region of from 450 to 600 nm. The organic compound having the maximum peak wavelength of light emission in the wavelength region of from 450 to 600 nm has a wavelength conversion function by which to absorb light or the corresponding energy in the wavelength ranging from ultraviolet light to visible light, and generate light having the maximum peak wavelength of light emission in the wavelength region of from 450 to 600 nm. Light having a long wavelength is characterized by being less scattered and absorbed in a scintillator layer than light having a short wavelength. Thus, containing the organic compound in a scintillator layer makes it possible that the short-wavelength emitted light in the light emitted from a phosphor is converted to long-wavelength emitted light, and that the emitted light is inhibited from being scattered and absorbed in the scintillator layer. This can enhance the efficiency of light takeout from a scintillator layer and enhance the sensitivity and sharpness of the scintillator panel. The organic compound has the maximum peak wavelength of light emission preferably in the range of from 480 to 590 nm, more preferably 500 to 580 nm. In addition, the organic compound has the maximum peak wavelength of absorption preferably in the range of from 300 to 540 nm, more preferably 350 to 520 nm.

The organic compound having the maximum peak wavelength of light emission in the wavelength region of from 450 to 600 nm is preferably dissolved and/or dispersed in a scintillator layer, thus making it possible to further enhance the sensitivity and sharpness of the scintillator panel. As used herein, “dissolved” refers to a state in which the organic compound having the maximum peak wavelength of light emission in the wavelength region of from 450 to 600 nm is uniformly present in the binder resin in the scintillator layer, and in which particles composed singly of the organic compound having the maximum peak wavelength of light emission in the wavelength region of from 450 to 600 nm are not observed in the binder resin by visual observation or with an optical microscope or an electron microscope. As used herein, “dispersed” refers to a state in which the organic compound having the maximum peak wavelength of light emission in the wavelength region of from 450 to 600 nm is uniformly present in the binder resin in the scintillator layer, and in which particles composed singly of the organic compound having the maximum peak wavelength of light emission in the wavelength region of from 450 to 600 nm are observed in the binder resin by visual observation or by observation with an optical microscope or an electron microscope. Observation with a microscope refers to observation at a measurement magnification ratio of 2 to 5000×. In this regard, examples of methods of dissolving and/or dispersing, in the scintillator layer, the organic compound having the maximum peak wavelength of light emission in the wavelength region of from 450 to 600 nm include the below-mentioned preferable method of producing a scintillator panel.

Preferable examples of organic compounds having the maximum peak wavelength of light emission in the wavelength region of from 450 to 600 nm include compounds selected from perylene compounds, pyrromethene compounds, coumarin compounds, and anthracene compounds. A perylene compound refers to a compound having a perylene backbone in the molecule, a pyrromethene compound refers to a compound having a pyrromethene backbone in the molecule, a coumarin compound refers to a compound having a coumarin backbone in the molecule, and an anthracene compound refers to a compound having an anthracene backbone in the molecule.

The perylene compound preferably has a structure represented by the following general formula (1).

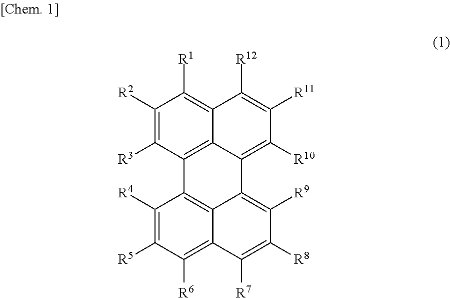

In the general formula (1), R¹ to R¹², the same or different, independently represent hydrogen, a substituted or unsubstituted alkyl group, substituted or unsubstituted heterocyclic ring group, substituted or unsubstituted alkenyl group, substituted or unsubstituted alkynyl group, hydroxyl group, thiol group, substituted or unsubstituted alkoxy group, substituted or unsubstituted aryl group, halogen, cyano group, aldehyde group, substituted or unsubstituted ester group, acyl group, carboxyl group, substituted or unsubstituted amino group, nitro group, or substituted or unsubstituted silyl group. Examples of substituents for substitution on these groups include halogen, an alkyl group, aryl group, heteroaryl group, and the like.

In the above-mentioned general formula (1), the alkyl group preferably has 1 to 12 carbon atoms. The alkenyl group preferably has 1 to 20 carbon atoms. The alkynyl group preferably has 1 to 10 carbon atoms. The heterocyclic ring group preferably has 2 to 20 carbon atoms. The alkoxy group preferably has 1 to 20 carbon atoms. The aryl group preferably has 6 to 40 carbon atoms. The ester group is preferably an alkyl ester having 1 to 6 carbon atoms. At least one of R¹ to R¹² is preferably an ester group, which makes it possible to further enhance the sensitivity and sharpness of a scintillator panel. R¹ and R⁷, or R⁶ and R¹², are more preferably ester groups. In cases where R¹ and R⁷, or R⁶ and R¹², are functional groups other than hydrogen, the others than these out of R¹ to R¹² are preferably hydrogen.

Preferable examples of pyrromethene compounds include pyrromethene boron complexes. Use of a boron complex further enhances quantum conversion efficiency, and thus allows more efficient wavelength conversion from short-wavelength light emission from a phosphor in the scintillator layer to longer-wavelength light emission.

The pyrromethene compound preferably has a structure represented by the following general formula (2).

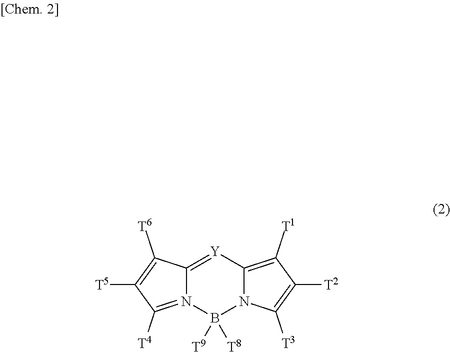

In the general formula (2), Y represents C-T⁷ or N.

T¹ to T⁷, the same or different, represent hydrogen, a substituted or unsubstituted alkyl group, substituted or unsubstituted cycloalkyl group, substituted or unsubstituted heterocyclic ring group, substituted or unsubstituted alkenyl group, substituted or unsubstituted cycloalkenyl group, substituted or unsubstituted alkynyl group, hydroxyl group, thiol group, substituted or unsubstituted alkoxy group, substituted or unsubstituted alkylthio group, substituted or unsubstituted arylether group, substituted or unsubstituted arylthioether group, substituted or unsubstituted aryl group, substituted or unsubstituted heteroaryl group, halogen, cyano group, aldehyde group, substituted or unsubstituted acyl group, carboxyl group, substituted or unsubstituted oxycarbonyl group, substituted or unsubstituted carbamoyl group, substituted or unsubstituted ester group, substituted or unsubstituted sulfonyl group, substituted or unsubstituted amide group, substituted or unsubstituted amino group, nitro group, substituted or unsubstituted silyl group, substituted or unsubstituted siloxanyl group, substituted or unsubstituted boryl group, or substituted or unsubstituted phosphine oxide group. Examples of substituents for substitution on these groups include halogen, an alkyl group, aryl group, heteroaryl group, and the like.

T⁸ and T⁹, the same or different, independently represent a substituted or unsubstituted alkyl group, substituted or unsubstituted cycloalkyl group, substituted or unsubstituted heterocyclic ring group, substituted or unsubstituted alkenyl group, substituted or unsubstituted cycloalkenyl group, substituted or unsubstituted alkynyl group, hydroxyl group, thiol group, substituted or unsubstituted alkoxy group, substituted or unsubstituted alkylthio group, substituted or unsubstituted arylether group, substituted or unsubstituted arylthioether group, substituted or unsubstituted aryl group, substituted or unsubstituted heteroaryl group, or halogen. Examples of substituents for substitution on these groups include halogen, an alkyl group, aryl group, heteroaryl group, and the like.

In the above-mentioned general formula (2), the alkyl group preferably has 1 to 20 carbon atoms, more preferably 1 to 8 carbon atoms. The cycloalkyl group preferably has 3 to 20 carbon atoms. The heterocyclic ring group preferably has 2 to 20 carbon atoms. The alkoxy group and the alkylthio group preferably have 1 to 20 carbon atoms. The arylether group, arylthioether group, and aryl group preferably have 6 to 40 carbon atoms. The heteroaryl group preferably has 2 to 30 carbon atoms. Examples of substituents on amino groups include an alkyl group, aryl group, heteroaryl group, and the like. At least part of the hydrogen atoms of these substituents may be further substituted. The silyl group preferably has 1 to 6 silicon atoms.

In the above-mentioned general formula (2), T¹, T³, T⁴, and T⁶ are each preferably hydrogen or a substituted or unsubstituted alkyl group because these do not extend the conjugation of the pyrromethene backbone and does not affect the light emission wavelength. They are each more preferably a substituted or unsubstituted alkyl group from the viewpoint of stability against oxygen and water in the air. Among alkyl groups, alkyl groups having 1 to 6 carbon atoms, such as a methyl group, ethyl group, n-propyl group, isopropyl group, n-butyl group, sec-butyl group, tert-butyl group, pentyl group, and hexyl group, are preferable from the viewpoint of solubility in a binder resin and a solvent, and alkyl groups having 1 to 4 carbon atoms are more preferable in terms of excellent thermal stability.

In the above-mentioned general formula (2), at least one of T² and T⁵ is preferably an electron-withdrawing group such as a substituted or unsubstituted acyl group, substituted or unsubstituted ester group, substituted or unsubstituted amide group, cyano group, or the like from the viewpoint of stability against oxygen.

T⁷ is preferably a substituted or unsubstituted aryl group or a substituted or unsubstituted heteroaryl group from the viewpoint of stability against light, more preferably a substituted or unsubstituted aryl group, still more preferably a substituted or unsubstituted phenyl group or substituted or unsubstituted naphthyl group.

In the general formula (2), T⁸ and T⁹ are preferably groups selected from fluorine, fluorine-containing alkyl groups, fluorine-containing heteroaryl groups, and fluorine-containing aryl groups, more preferably groups selected from fluorine and fluorine-containing aryl groups, still more preferably fluorine, in terms of easy synthesis.

Pyrromethene compounds can be synthesized by a conventionally known method. For example, as disclosed in WO2016/190283, JP2017-142887A, JP2017-141318A, and the like, such compounds can be synthesized by a method carried out using a pyrrole derivative.

The coumarin compound preferably has a structure represented by the following general formula (3).

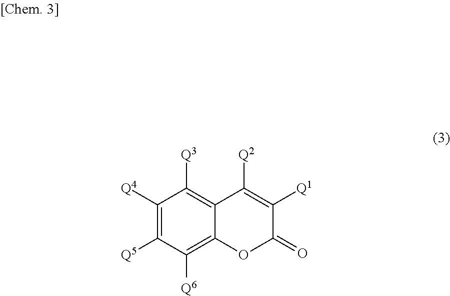

In the general formula (3), Q¹ to Q⁶, the same or different, represent hydrogen, a substituted or unsubstituted alkyl group, substituted or unsubstituted heterocyclic ring group, substituted or unsubstituted alkenyl group, substituted or unsubstituted alkynyl group, hydroxyl group, thiol group, substituted or unsubstituted alkoxy group, substituted or unsubstituted aryl group, halogen, cyano group, aldehyde group, substituted or unsubstituted ester group, acyl group, carboxyl group, sulfonyl group, substituted or unsubstituted amino group, nitro group, or substituted or unsubstituted silyl group. Examples of substituents for substitution on these groups include halogen, an alkyl group, hydroxyl group, aryl group, heteroaryl group, and the like.

In the above-mentioned general formula (3), the alkyl group preferably has 1 to 10 carbon atoms. The alkenyl group preferably has 1 to 20 carbon atoms, and the alkynyl group preferably has 1 to 10 carbon atoms. The heterocyclic ring group preferably has 2 to 20 carbon atoms. The alkoxy group preferably has 1 to 20 carbon atoms. The aryl group preferably has 6 to 40 carbon atoms. The ester group is preferably an alkyl ester having 1 to 6 carbon atoms. At least one of Q¹ to Q⁶ preferably has a functional group other than hydrogen, and more preferably, at least one of Q¹ and Q² has a functional group other than hydrogen. Furthermore, Q⁵ is preferably an electron-donating group. The electron-donating group is preferably a hydroxyl group, substituted or unsubstituted amino group, or substituted or unsubstituted alkoxy group, more preferably a substituted or unsubstituted amino group. Examples of substituents for substitution on these groups include an alkyl group, aryl group, heteroaryl group, and the like. The alkyl group for substitution preferably has 1 to 10 carbon atoms.

The anthracene compound preferably has a structure represented by the following general formula (4).

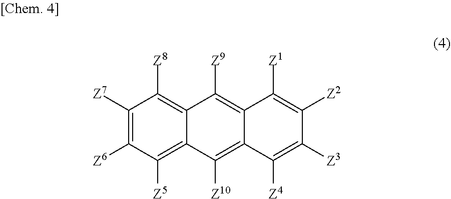

In the general formula (4), Z¹ to Z¹⁰, the same or different, independently represent hydrogen, a substituted or unsubstituted alkyl group, substituted or unsubstituted heterocyclic ring group, substituted or unsubstituted alkenyl group, substituted or unsubstituted alkynyl group, hydroxyl group, thiol group, substituted or unsubstituted alkoxy group, substituted or unsubstituted aryl group, halogen, cyano group, aldehyde group, substituted or unsubstituted ester group, acyl group, carboxyl group, sulfonyl group, substituted or unsubstituted amino group, nitro group, or substituted or unsubstituted silyl group. Examples of substituents for substitution on these groups include halogen, an alkyl group, hydroxyl group, aryl group, heteroaryl group, and the like.

In the above-mentioned general formula (4), the alkyl group preferably has 1 to 10 carbon atoms. The alkenyl group preferably has 1 to 20 carbon atoms, and the alkynyl group preferably has 1 to 10 carbon atoms. The heterocyclic ring group preferably has 2 to 20 carbon atoms. The alkoxy group preferably has 1 to 20 carbon atoms. The aryl group preferably has 6 to 40 carbon atoms. The ester group is preferably an alkyl ester having 1 to 6 carbon atoms. The alkyl group for substitution preferably has 1 to 12 carbon atoms. At least one of Z¹ to Z¹⁰ preferably has a functional group other than hydrogen, and more preferably, at least one of Z⁹ and Z¹⁰ has a functional group other than hydrogen.

In an embodiment of the present invention, the scintillator layer contains the organic compound having the maximum peak wavelength of light emission in the range of from 450 to 600 nm, and thus, the wavelength of light emitted from the scintillator layer can be matched with the high sensitivity wavelength region of the below-mentioned photoelectric conversion layer, making it possible to enhance the detection efficiency for light emitted from the scintillator layer. Here, the maximum peak wavelength of light emission of the organic compound refers to a wavelength at which the light emission intensity is the largest in measurement of the light emission spectrum of the organic compound in the wavelength of from 370 to 670 nm. In this regard, such a light emission spectrum can be measured using a fluorescence spectrophotometer to irradiate the organic compound with light having a wavelength of 350 nm. Examples of compounds having the maximum peak wavelength of light emission in the range of from 450 to 600 nm include the below-mentioned compounds.

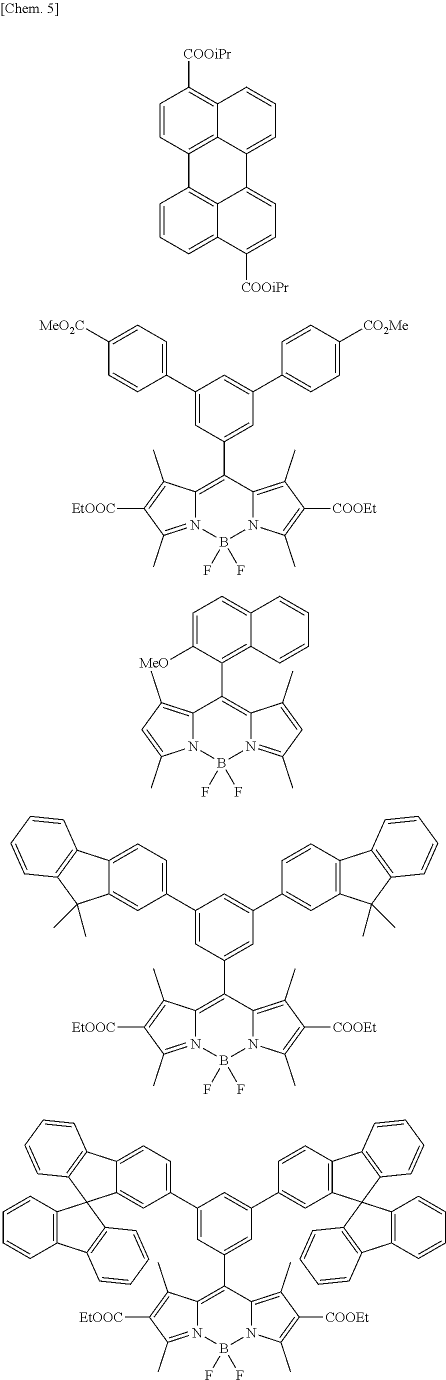

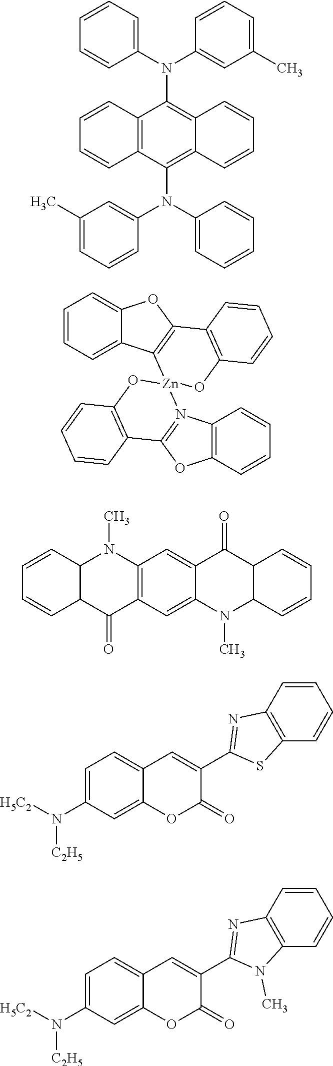

Next, a method of producing a scintillator panel according to an embodiment of the present invention will be described. For example, an organic compound having the maximum peak wavelength of light emission in the wavelength region of from 450 to 600 nm is dissolved or dispersed in a solution of a binder resin dissolved in a solvent, and furthermore, a phosphor is dispersed in the solution to obtain a paste, which is then applied to a substrate and dried so that a scintillator layer in which the organic compound having the maximum peak wavelength of light emission in the wavelength region of from 450 to 600 nm is dissolved and/or dispersed can be formed on the substrate. Examples of methods of dissolving or dispersing, in a binder resin solution, an organic compound having the maximum peak wavelength of light emission in the wavelength region of from 450 to 600 nm include a method in which the organic compound is added to the binder resin solution, followed by stirring the resulting solution. The stirring rate is preferably 10 to 100 rpm, and the stirring time is preferably 2 to 24 hours. The drying temperature is preferably 40 to 110° C., and the drying time is preferably 10 minutes to 300 minutes.

Next, an X-ray detector according to an embodiment of the present invention will be described. An X-ray detector according to the present invention can be obtained by disposing the above-mentioned scintillator panel on an output substrate having a photoelectric conversion layer. The output substrate has a photoelectric conversion layer and an output layer on the substrate. In general, the photoelectric conversion layer is two-dimensionally formed pixels and has a photosensor and TFT.

The photoelectric conversion layer preferably has a high sensitivity region in the wavelength of from 450 to 600 nm. Here, a high sensitivity region in an embodiment of the present invention refers to a wavelength region in which a photoelectric conversion layer has a sensitivity of 90% or more, with respect to the maximum value of the sensitivity, in the wavelength region of from 350 to 700 nm. Having a high sensitivity region in such a wavelength range makes it possible to detect, with a higher sensitivity, long-wavelength light in the light emitted in the scintillator layer, wherein the long-wavelength light is easily transmitted up to the face of the photoelectric conversion layer. Furthermore, allowing the scintillator layer to contain the organic compound having the maximum peak wavelength of light emission in the wavelength region of from 450 to 600 nm enables the wavelength of light emitted from the scintillator layer to be matched with the high sensitivity wavelength region of the photoelectric conversion layer, making it possible to enhance the sensitivity of the scintillator panel.

Next, an X-ray fluoroscope and an X-ray CT device according to an embodiment of the present invention will be described. An X-ray fluoroscope and an X-ray CT device according to an embodiment of the present invention have an X-ray generation unit for generating an X-ray and the above-mentioned X-ray detector. The X-ray fluoroscope and the X-ray CT device are devices which irradiate an object with an X-ray from the X-ray generation unit and allows the X-ray detector to detect the X-ray transmitted through the object. Mounting the X-ray detector according to an embodiment of the present invention in the X-ray detection unit makes it possible to detect, with high sensitivity, an X-ray transmitted through an object, and to obtain an X-ray fluoroscope or an X-ray CT device which has high sensitivity.

### EXAMPLES

The present invention will be described in more detail below by way of Examples and Comparative Examples; however, the present invention is not limited thereto. First, the materials used in Examples and Comparative Examples are shown below.

Phosphor: GOS:Tb (manufactured by Nichia Corporation; in the form of particles; having an average particle diameter of 11 μm)

Binder resin: polystyrene (manufactured by Wako Pure Chemical Industries, Ltd.; having a degree of polymerization of 2000)

Organic fluorescent material 1: 1,4-bis(2-(5-phenyloxazolyl))benzene (POPOP: having the maximum peak wavelength of approximately 420 nm) (manufactured by DOJINDO LABORATORIES)

Solvent: γ-butyrolactone (γ-BL)

Perylene compound: diisobutyl 3,9-perylenedicarboxylate (manufactured by BASF SE)

Pyrromethene compound A: a compound represented by the following structural formula

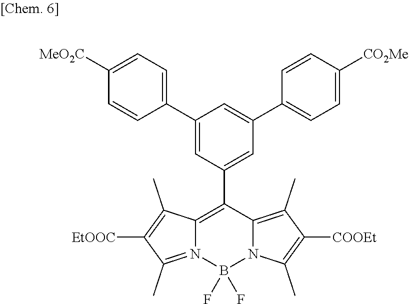

Pyrromethene compound B: a compound represented by the following structural formula

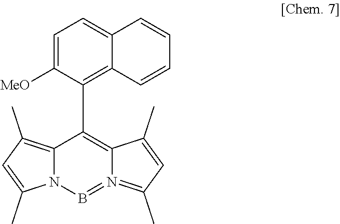

Pyrromethene compound C: a compound represented by the following structural formula

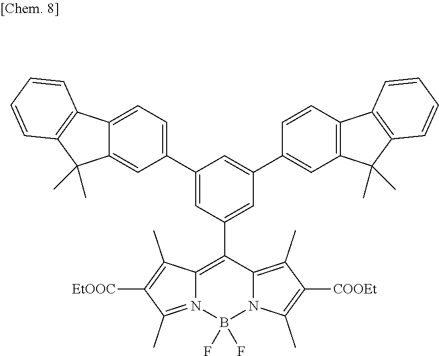

Pyrromethene compound D: a compound represented by the following structural formula

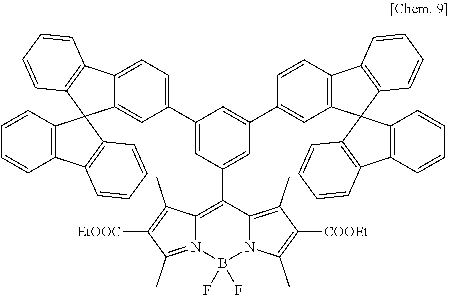

Coumarin compound: 3-(2-benzothiazolyl)-7-(diethylamino)coumarin (manufactured by Tokyo Chemical Industry Co., Ltd.)

Anthracene compound: N, N′-bis(3-methylphenyl)-N, N′-diphenyl-9,10-anthracenediamine (manufactured by Tokyo Chemical Industry Co., Ltd.)

### (Preparation Examples 1 to 9) Preparation of Resin Solution

Into a stirring container, 30 g of polystyrene and 50 g of γ-butyrolactone (γ-BL) were added, the resulting solution was stirred for eight hours under heating at 60° C. to obtain a γ-BL solution of polystyrene. Then, the raw material shown in Table 1 was added into the stirring container at a mixing ratio shown in Table 1, and the resulting mixture was stirred at room temperature for 12 hours to obtain a resin solution. The state of the organic compound in the resin solution was visually observed.

TABLE 1

| | Preparation | Preparation | Preparation | Preparation | Preparation | Preparation | Preparation | Preparation | Preparation |
|---|---|---|---|---|---|---|---|---|---|
| | Example 1 | Example 2 | Example 3 | Example 4 | Example 5 | Example 6 | Example 7 | Example 8 | Example 9 |
| Perylene Compound | 0.054 | — | — | — | — | — | — | — | — |
| (parts by weight) | | | | | | | | | |
| Pyrromethene | — | 0.09 | — | — | — | — | — | — | — |
| Compound A | | | | | | | | | |
| (parts by weight) | | | | | | | | | |
| Pyrromethene | — | — | 0.045 | — | — | — | — | — | — |
| Compound B | | | | | | | | | |
| (parts by weight) | | | | | | | | | |
| Pyrromethene | — | — | — | 0.105 | — | — | — | — | — |
| Compound C | | | | | | | | | |
| (parts by weight) | | | | | | | | | |
| Pyrromethene | — | — | — | — | 0.135 | — | — | — | — |
| Compound D | | | | | | | | | |
| (parts by weight) | | | | | | | | | |
| Coumarin Compound | — | — | — | — | — | 0.043 | — | — | — |
| (parts by weight) | | | | | | | | | |
| Anthracene | — | — | — | — | — | — | 0.066 | — | — |
| Compound | | | | | | | | | |
| (parts by weight) | | | | | | | | | |
| POPOP | — | — | — | — | — | — | — | — | 0.045 |
| (parts by weight) | | | | | | | | | |
| γ-BL Solution of | 80 | 80 | 80 | 80 | 80 | 80 | 80 | 80 | 80 |
| Polystyrene | | | | | | | | | |
| (parts by weight) | | | | | | | | | |
| State of Organic | dissolved | dissolved | dissolved | dissolved | dissolved | dissolved | dissolved | dispersed | — |
| Compound in Resin | | | | | | | | | |
| Solution | | | | | | | | | |

### (Preparation Examples 10 to 18) Preparation of Scintillator Layer Paste

The resin solutions prepared by the method described in Preparation Examples 1 to 9 were each added into a stirring container, and to the solution, 78 parts by weight of solvent and 625 parts by weight of phosphor with respect to 100 parts by weight of resin solution were added and mixed as shown in Table 2. Using a planetary mixer/deaerator (“Mazerustar” (registered trademark) KK-400; manufactured by Kurabo Industries Ltd.), the resulting mixture was stirred and deaerated at a rotational speed of 1000 rpm for 20 minutes to obtain a scintillator layer paste.

TABLE 2

| | Preparation | Preparation | Preparation | Preparation | Preparation | Preparation | Preparation | Preparation | Preparation |
|---|---|---|---|---|---|---|---|---|---|
| | Example 10 | Example 11 | Example 12 | Example 13 | Example 14 | Example 15 | Example 16 | Example 17 | Example 18 |
| Resin | Preparation | Preparation | Preparation | Preparation | Preparation | Preparation | Preparation | Preparation | Preparation |
| Solution | Example 1 | Example 2 | Example 3 | Example 4 | Example 5 | Example 6 | Example 7 | Example 8 | Example 9 |
| Solvent | γ-BL | γ-BL | γ-BL | γ-BL | γ-BL | γ-BL | γ-BL | γ-BL | γ-BL |
| Phosphor | GOS:Tb | GOS:Tb | GOS:Tb | GOS:Tb | GOS:Tb | GOS:Tb | GOS:Tb | GOS:Tb | GOS:Tb |

Next, the evaluation methods in Examples and Comparative Examples will be described.

1. Absorption Spectra of Perylene Compound, Pyrromethene Compound, Coumarin Compound, and Anthracene Compound

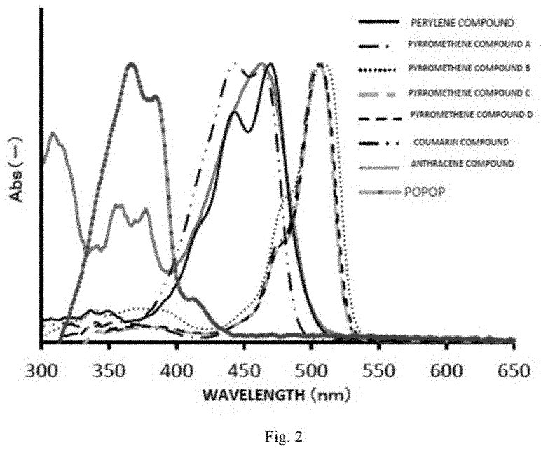

The resin solutions obtained in Preparation Examples 1 to 9 were each applied to a PET film and dried at 80° C. for two hours to obtain a resin film. The obtained resin film was measured for absorption spectrum in the wavelength of from 300 to 650 nm using an ultraviolet and visible spectrophotometer (U-4100; manufactured by Hitachi High-Tech Science Corporation). The obtained absorption spectra are shown in FIG. 2. The absorption spectra shown in FIG. 2 have revealed that the perylene compound had an absorption wavelength of approximately 310 nm to 510 nm, the pyrromethene compounds A to D approximately 310 nm to 540 nm, the coumarin compound approximately 300 nm to 500 nm, the anthracene compound approximately 300 nm to 520 nm, and the POPOP approximately 310 nm to 450 nm.

2. Maximum Peak Wavelength of Light Emission of Perylene Compound, Pyrromethene Compound, Coumarin Compound, and Anthracene Compound

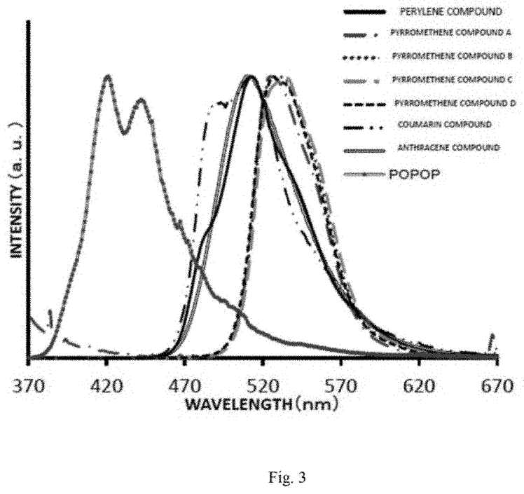

The resin solutions obtained as described in Preparation Examples 1 to 9 were each applied to a PET film and dried at 80° C. for two hours to obtain a resin film. Using a fluorescence spectrophotometer (Fluoromax 4; manufactured by Horiba, Ltd.), the obtained resin film was irradiated with light having a wavelength of 350 nm, and measured for light emission spectrum in the wavelength of from 370 to 670 nm. The obtained light emission spectra are shown in FIG. 3. The wavelength at which the light emission intensity was the largest in the wavelength region used for measurement was regarded as the maximum peak wavelength of light emission. The light emission spectra shown in FIG. 2 have revealed that the perylene compound had the maximum peak wavelength of approximately 510 nm, the pyrromethene compounds A to D approximately 540 nm, the coumarin compound approximately 510 nm, the anthracene compound approximately 510 nm, and the POPOP approximately 420 nm.

3. Light Emission Spectrum of Scintillator Panel

Using a fluorescence spectrophotometer (Fluoromax 4; manufactured by Horiba, Ltd.), the scintillator panels obtained in Examples 1 to 2, 6 and 7, and Comparative Examples 1 were each irradiated with light having a wavelength of 250 nm, and measured for light emission spectrum in the wavelength of from 350 to 700 nm.

4. Sensitivity and Sharpness of Scintillator Panel

The scintillator panels produced in Examples and Comparative Examples were each set in an FPD (Paxscan 2520V (manufactured by Varian Medical Systems, Inc.)) having a photoelectric conversion layer the high sensitivity region of which was in the wavelength of from 450 to 600 nm, and an X-ray detector was thus produced. The scintillator panel was irradiated on the substrate side thereof with an X-ray at a tube voltage of 50 kVp, and the light emission of the scintillator was detected with the FPD. The sensitivity was calculated from the X-ray dosage detected by the light emission detection and the slope of the graph of digital values of the digital image detected with the FPD. In addition, the sharpness values were calculated using the edge method, and out of the calculated values, the value at 2 line pairs/mm was regarded as the value of sharpness. The values of sensitivity and sharpness were each converted to a relative value with respect to 100% of the value measured in Comparative Example 1, and used for relative comparison.

### Examples 1 to 7

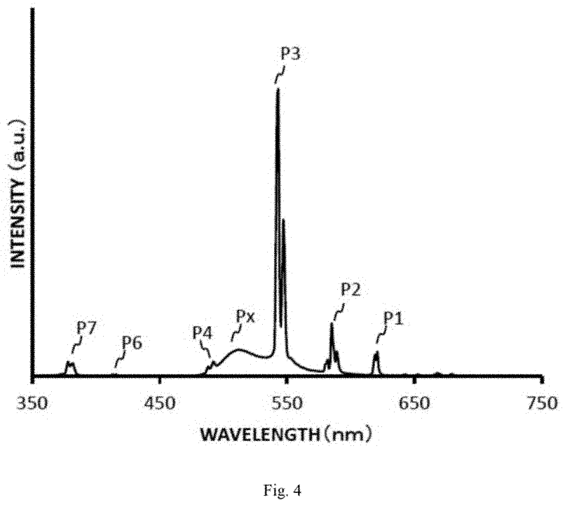

The scintillator layer pastes obtained according to Preparation Examples 10 to 16 were each applied to a PET film using a bar coater and dried at 80° C. for four hours so that the paste could have a film thickness of 200 m after being dried. In this manner, a scintillator panel in which a scintillator layer was formed on a PET film was obtained. The obtained scintillator panels were evaluated by the above-mentioned methods, and the results are shown in Table 3. The state of the organic compound in the scintillator layer was visually observed. The light emission spectra of the scintillator panels according to Examples 1, 2, 6, and 7 are shown in FIGS. 4 to 7 respectively.

In the light emission spectrum of the scintillator panel according to Example 1 shown in FIG. 4, the light emission peaks from the first light emission peak P1 to the third light emission peak P3 are each a peak due to the light emission from the phosphor. In addition, comparison with the below-mentioned Comparative Example 1 reveals that the fourth light emission peak P4, the sixth light emission peak P6, and the seventh light emission peak P7 decreased in light emission intensity, and that the fifth light emission peak P5 vanished. Furthermore, a wide-ranging light emission peak Px which was not found in Comparative Example 1 was observed at a wavelength of approximately 510 nm. The decrease or vanishment of the light emission peaks P4 to P7 and the rise of the light emission peak Px were due to the light absorption and emission of the perylene compound. The maximum peak wavelength of the scintillator layer according to Example 1 matched with the high sensitivity region of the photoelectric conversion layer, and this is considered to be the reason why the sensitivity can be enhanced with the high sharpness maintained.

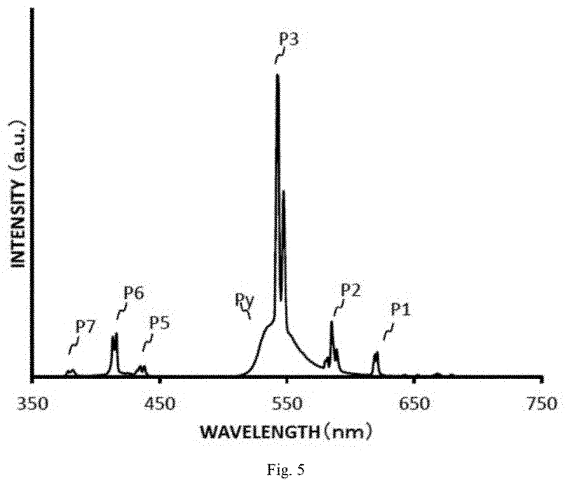

The light emission spectrum of the scintillator panel according to Example 2 shown in FIG. 5 reveals that the light emission peaks P4 to P7 decreased in light emission intensity, and that the light emission peak Py rose at approximately 530 nm. The decrease and vanishment of the light emission peaks P4 to P7 and the rise of the light emission peak Px were due to the light absorption and emission of the pyrromethene compound A. The maximum peak wavelength of the scintillator layer according to Example 2 matched with the high sensitivity region of the photoelectric conversion layer, and this is considered to be the reason why the sensitivity can be enhanced with the high sharpness maintained.

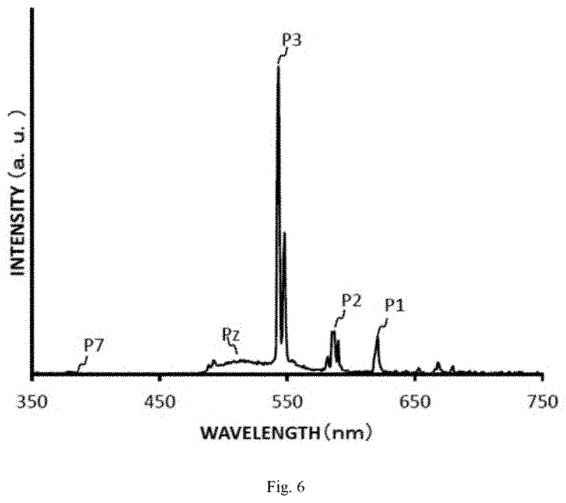

The light emission spectrum of the scintillator panel according to Example 6 shown in FIG. 6 reveals that the light emission peak P7 decreased in light emission intensity, that the light emission intensity between the light emission peaks P5 and P6 vanished, and that the light emission peak Pz rose at approximately 510 nm. The decrease and vanishment between the light emission peaks P5 and P7 and the rise of the light emission peak Pz were due to the light absorption and emission of the coumarin compound. The maximum peak wavelength of the scintillator layer according to Example 6 matched with the high sensitivity region of the photoelectric conversion layer, and this is considered to be the reason why the sensitivity can be enhanced with the high sharpness maintained.

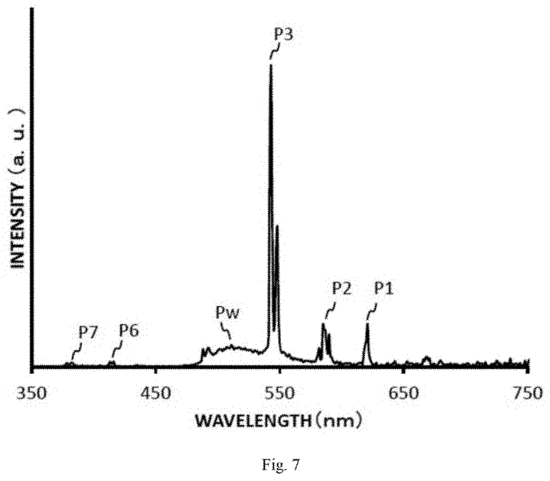

The light emission spectrum of the scintillator panel according to Example 7 shown in FIG. 7 reveals that the light emission peaks P6 and P7 decreased in light emission intensity, that the light emission peak P5 vanished, and that the light emission peak Pw rose at approximately 510 nm. The decrease and vanishment between the light emission peaks P5 to P7 and the rise of the light emission peak Pw were due to the light absorption and emission of the anthracene compound. The maximum peak wavelength of the scintillator layer according to Example 7 matched with the high sensitivity region of the photoelectric conversion layer, and this is considered to be the reason why the sensitivity can be enhanced with the high sharpness maintained.

### Comparative Example 1

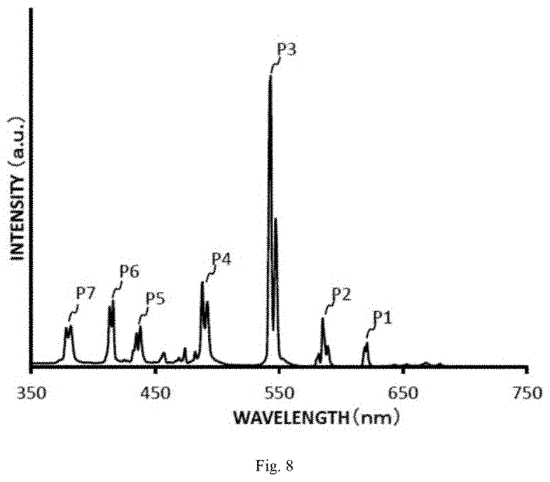

A scintillator panel was obtained in the same manner as in Example 1 except that a scintillator layer paste obtained according to Preparation Example 17 was used. The obtained scintillator panel was evaluated by the above-mentioned methods, and the results are shown in Table 3. The light emission spectrum of the scintillator panel is shown in FIG. 8. As shown in FIG. 8, the first light emission peak P1, the second light emission peak P2, the third light emission peak P3, the fourth light emission peak P4, the fifth light emission peak P5, the sixth light emission peak P6, and the seventh light emission peak P7 were observed.

### Comparative Example 2

A scintillator panel was obtained in the same manner as in Example 1 except that a scintillator layer paste obtained according to Preparation Example 18 was used. The obtained scintillator panel was evaluated by the above-mentioned methods, and the results are shown in Table 3.

### Comparative Example 3

The resin solution obtained by the method described in Preparation Example 1 was applied to a PET film and dried at 80° C. for two hours to obtain a resin film. The obtained resin film was laminated on the scintillator layer formed in the same manner as in Comparative Example 1, and thus, a scintillator panel was obtained. The obtained scintillator panel was evaluated by the above-mentioned methods, and the results are shown in Table 4.

### Comparative Example 4

The resin solution obtained by the method described in Preparation Example 2 was applied to a PET film and dried at 80° C. for two hours to obtain a resin film. The obtained resin film was laminated on the scintillator layer formed in the same manner as in Comparative Example 1, and thus, a scintillator panel was obtained. The obtained scintillator panel was evaluated by the above-mentioned methods, and the results are shown in Table 4.

TABLE 3

| | | | | | | | | Comparative | Comparative |
|---|---|---|---|---|---|---|---|---|---|
| | Example 1 | Example 2 | Example 3 | Example 4 | Example 5 | Example 6 | Example 7 | Example 1 | Example 2 |
| Scintillator Layer | Preparation | Preparation | Preparation | Preparation | Preparation | Preparation | Preparation | Preparation | Preparation |
| Paste | Example 10 | Example 11 | Example 12 | Example 13 | Example 14 | Example 15 | Example 16 | Example 17 | Example 18 |
| Additive in Paste | Perylene | Pyrromethene | Pyrromethene | Pyrromethene | Pyrromethene | Coumarin | Anthracene | — | POPOP |
| | Compound | Compound A | Compound B | Compound C | Compound D | Compound | Compound | | |
| State of Organic | dissolved | dissolved | dissolved | dissolved | dissolved | dissolved | dissolved | — | dispersed |
| Compound in | | | | | | | | | |
| Scintillator Layer | | | | | | | | | |
| Support | PET Film | PET Film | PET Film | PET Film | PET Film | PET Film | PET Film | PET Film | PET Film |
| Sensitivity (%) | 106 | 106 | 105 | 106 | 107 | 109 | 105 | 100 | 102 |
| Sharpness (%) | 100 | 100 | 100 | 100 | 100 | 100 | 100 | 100 | 100 |

The evaluation results of Examples 1 to 7 have revealed that allowing the scintillator layer to contain a perylene compound, pyrromethene compound, coumarin compound, or anthracene compound enhances the sensitivity with the sharpness maintained.

TABLE 4

| | Comparative | Comparative |
|---|---|---|
| | Example 3 | Example 4 |
| Scintillator | Preparation | Preparation |
| Layer Paste | Example 17 | Example 17 |
| Solution for | Preparation | Preparation |
| Resin Film | Example 1 | Example 2 |
| Support | PET Film | PET Film |
| Sensitivity (%) | 102 | 101 |
| Sharpness (%) | 81 | 77 |

Comparative Examples 3 and 4 are different from Examples in that the scintillator layer does not contain the organic compound having the maximum peak wavelength of light emission in the wavelength region of from 450 to 600 nm and that a polystyrene film containing a perylene compound or a pyrromethene compound is laminated on the scintillator layer. The light emitted in the scintillator layer is converted to a wavelength in the high sensitivity region of the photoelectric conversion layer by the polystyrene film containing a perylene compound or a pyrromethene compound, and thus, the detection efficiency of the photoelectric conversion layer is enhanced. However, this wavelength conversion takes place not inside the scintillator layer but outside the scintillator layer, and thus, the scattering and absorption of light emitted inside the scintillator layer cannot be inhibited. Thus, the takeout efficiency of light from the scintillator layer was not enhanced, and the sensitivity enhancement effect was insufficient compared with Examples 1 to 7. Furthermore, having a polystyrene film at the interface increased the distance between the photoelectric conversion layer and the scintillator panel, and decreased the sharpness.

### DESCRIPTION OF REFERENCE SIGNS

1: X-ray detector
2: Scintillator panel
3: Output substrate
4: Scintillator layer
5: Substrate
6: Phosphor
7: Binder resin
8: Barrier membrane layer
9: Photoelectric conversion layer
10: Output layer
11: Substrate
12: Power source part

The invention claimed is:

1. A scintillator panel comprising a substrate and a scintillator layer containing a binder resin and a phosphor, wherein said scintillator layer further contains an organic compound having the maximum peak wavelength of light emission in the wavelength region of from 450 to 600 nm.

2. The scintillator panel according to claim 1, wherein said organic compound having the maximum peak wavelength of light emission in the wavelength region of from 450 to 600 nm is dissolved and/or dispersed in said scintillator layer.

3. The scintillator panel according to claim 1, wherein said organic compound having the maximum peak wavelength of light emission in the wavelength region of from 450 to 600 nm contains a compound selected from a perylene compound, pyrromethene compound, coumarin compound, and anthracene compound.

4. The scintillator panel according to claim 3, wherein said pyrromethene compound contains a pyrromethene boron complex.

5. An X-ray detector comprising said scintillator panel according to claim 1 and an output substrate having a photoelectric conversion layer.

6. The X-ray detector according to claim 5, wherein said photoelectric conversion layer has a high sensitivity wavelength region of from 450 to 600 nm.

7. An X-ray fluoroscope comprising said X-ray detector according to claim 5.

8. An X-ray CT device comprising said X-ray detector according to claim 5.
